(19) United States
(12) Patent Application Publication
(10) Pub. No.: US 2026/0257925 A1
(43) Pub. Date: Sep. 3, 2026

(54) METHOD OF RECYCLING SILICON COMPONENTS

(71) Applicant: FLAXTEC GMBH, Dresden (DE)

(72) Inventors: Olaf ZEIKA, Meißen (DE); Michael Rudolf HEUSCHKEL, Radebeul (DE); Harald GROSS, Langebrück (DE)

(73) Assignee: FLAXTEC GMBH, Dresden (DE)

(21) Appl. No.: 18/834,475

(22) PCT Filed: Dec. 21, 2022
(86) PCT No.: PCT/DE2022/200312

§ 371 Date: Jul. 30, 2024

(30) Foreign Application Priority Data
Feb. 1, 2022 (DE) 10 2022 102 309.5

(51) Int. Cl. C01B 33/32; C01B 3/06; C22B 3/12; C22B 11/00

(52) U.S. Cl. CPC C01B 33/325; C01B 3/06; C22B 3/12; C22B 11/046

(57) ABSTRACT

The present invention relates to a method of physical and energetic utilization of silicon components that are obtained in electrical scrap recycling. In order to create a recycling method which is effective in terms of time, plant technology and energy, it is proposed that a silicon component be dissolved in an alkali under the process pressure (p) and a first suspension temperature in the range from 50° C. to equal to or greater than the boiling point of the alkali at the process pressure p. After the silicon has been dissolved, the resultant suspension is filtered for separation of meta-, di- and oligosilicate, and the second suspension temperature is maintained during the filtration within the temperature range specified from 50 to less than the boiling point of the alkali.

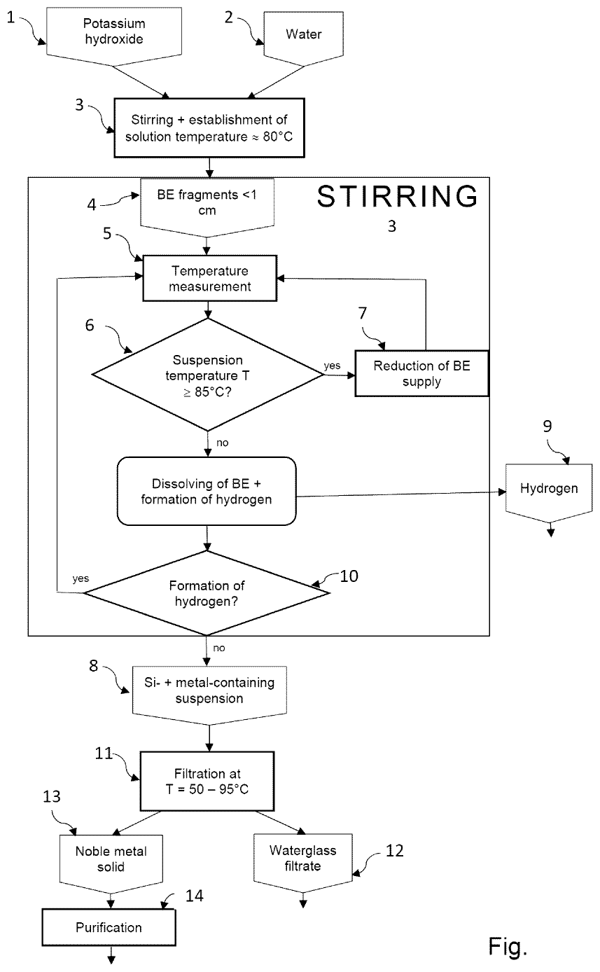

### CROSS-REFERENCE TO RELATED APPLICATION

This application is a national stage application, filed under 35 U.S.C. § 371, of International Patent Application PCT/DE2022/200312, filed on Dec. 21, 2022, which claims the benefit of German Patent Application DE 10 2022 102 309.5, filed on Feb. 1, 2022.

### TECHNICAL FIELD

The disclosure generally relates to a process for material recovery of silicon-containing components generated in electronic waste recycling to obtain secondary raw materials. The process further relates to energy recovery of the silicon-containing components and in particular that of solar wafers generated in the recycling of photovoltaic modules.

### BACKGROUND

Material recovery of the silicon-containing components effects recovery of materials present in the components for reuse in products. Depending on the material and the cost and complexity of separation thereof in the desired purity the obtained material may be obtained in a form comparable to the original raw material (raw material recovery) or be available as a modified or new material (derivative recovery) for another use.

The silicon-containing components supplied to the recovery are to be understood as meaning constituents of electronic components freed of housings or comparable cover and carrier substrates, including cover films, still containing substantially only the layer stack of the silicon and metallic or dielectric layers/conductor traces applied thereto. Typical materials for recovery thus include for example aluminum, silver, molybdenum and other metals as well as dielectric layers such as for example silicon nitride in addition to the semiconductor silicon. Additional and other materials may also be present depending on the electronic component. The remaining layer stack of the silicon component, whose layers are surficially joined to one another, served the actual function of the electronic component.

A series of attempts have been made to obtain semiconductor silicon in high purity from electronic waste, in particular from silicon components.

The layer stacks of the silicon components to be recovered include for example those obtained from electronic components after removal of their housings, typically made of polymers, or their cover, such as glass and/or plastic films. In the case of photovoltaic modules the silicon components are covered by glass and/or plastic layers. Thus about 85% of all photovoltaic modules produced are composed substantially of a laminate of successive materials in the form of a layer stack: Glass pane/top plastic film/a plurality of silicon wafers arranged side by side in a plane parallel to the glass panel including metallization layers for electrical contacting of the wafers/film laminate. The latter is composed of a plurality of plastic films. The separation of the wafer layer from the films and the glass may be effected by various suitable processes. Thus for example in WO 2018/137735 A1 the front side of a photovoltaic module is irradiated with intense visible light from a flash lamp through the front glass pane for less than one second. The incident light is absorbed by the material layer therebelow formed from silicon wafers arranged side by side in a plane. The light absorption causes heating of the material layer and consequent detachment of the adjacent plastic films due to the pressure of the pyrolysis gases formed in the interface between the silicon and the plastic layers.

To extract the pure semiconductor not only the metals but also the doping layer must be removed inter alia via a series of chemical processes. Determining the type and extent of doping is moreover very involved and so recycling of the semiconductor in the purity required for reuse in silicon-containing components appears ecologically and economically unviable.

In order to obtain the silver present in the silicon-containing components a proposed “liftoff process” in WO2020240126A1 comprises separating the silver as a solid by surface etching.

### SUMMARY

There is presently an increasing need for recycling of silicon wafers, in particular of solar modules, since these are in need of replacement. However, the known, multistage processes make the recycling too complex and costly.

There is therefore a need for a recovery process which is efficient in terms of time, plant and energy and which makes it possible to effect material recovery of large amounts of silicon-containing components and to send the different materials present in the components to a reuse to a greater extent than has hitherto been practiced.

This comprehends that the materials obtainable from the process are present separated from one another to the greatest possible extent and at acceptable cost and complexity. Limitation to acceptable cost and complexity comprehends that not necessarily the same materials or material compositions that were added to the silicon-containing component during production thereof are obtained, for example high-purity crystalline silicon. That is to say the original materials may also be obtained in material compositions which comprise a plurality of constituents of the silicon-containing component or else materials added in the course of the recovery process.

The need for energy efficient utilization comprehends that the process is to be operated such that supply of primary energy is required only to a small extent, if at all.

In the process disclosed within this application the at least one silicon-containing component, on an industrial scale a multiplicity thereof, is dissolved in an alkaline solution.

It is in principle possible to employ any alkaline solution capable of dissolving the silicon-containing component. Thus for example alkaline solutions used in the production of electronic silicon-containing components for etching the silicon may be used. It is alternatively also possible to employ other alkaline solutions, including organic alkaline solutions, provided their behavior towards the materials, in particular the silicon, and the noble and non-noble metals, corresponds to the behavior of the recited inorganic alkaline solutions described below.

One embodiment of the process employs an alkaline solution or a mixture of alkaline solutions constituting a hydroxide of an alkali metal or of an alkaline earth metal. The latter exhibit behavior towards the silicon and the metals that is similar to the former but attenuated. It is alternatively possible to employ an alkaline solution of ammonium hydroxide. The alkaline solution may be selected for example according to the type of waterglass that is to be produced and/or the parameters such as material composition, layer thicknesses and others exhibited by the silicon-containing component. Selection criteria for the alkaline solution further include the cost, time and energy demand of the process and hazardousness to health.

By way of example and without limitation it is possible to employ aqueous solutions of potassium hydroxide, magnesium hydroxide, calcium hydroxide, strontium hydroxide, barium hydroxide, lithium hydroxide, rubidium hydroxide and cesium hydroxide. It is especially possible to employ sodium hydroxide solution (aqueous solution of sodium hydroxide) and potassium hydroxide solution (aqueous solution of potassium hydroxide). The multiplicity of employable bases makes it possible to eschew sodium hydroxide solution (aqueous solution of sodium hydroxide) which, while cost-effective to provide in large quantities, is hazardous to health. It is advantageous that sodium hydroxide solution in particular is cost-effective to provide in large amounts.

Production of a potassium hydroxide solution or a sodium hydroxide solution comprises dissolving potassium hydroxide or sodium hydroxide in water for example. The chemical reaction equation when using potassium hydroxide solution for recovering a silicon-containing component is as follows

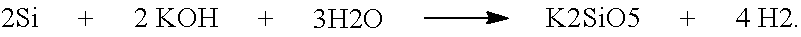

In addition to the employed alkaline solution and to the temperature of the alkaline solution and the suspension the process can also be influenced through further parameters.

The type, shape and size of the particles of the silicon-containing components added to the alkaline solution also influences the process and so in a further embodiment of the process the silicon-containing component is comminuted before addition to the alkaline solution, thus making it possible to influence the viscosity of the suspension. A particularly significant acceleration of the dissolving is achieved in the case of particle sizes having a largest extent of less than 1 cm. It is preferable to effect comminution to particles smaller than 0.5 cm, more preferably smaller than 2 mm, more preferably smaller than 1 mm or 0.5 mm. Various processes for producing the fragments of silicon-containing components may accordingly be applied.

In connection with the particles per se a more efficient stirring of the suspension also has a noticeably accelerating effect. The dissolving process can be optimized here by means of the shape, the position, the number and the speed of the stirrer or stirrers. The same applies to the mixing of the suspension upon addition of the particles. It is further also possible to achieve different process sequences by either adding the alkaline solution to the silicon-containing components, comminuted or whole, or vice versa.

To this end it is placed, comminuted or in its uncomminuted size, in an alkaline solution bath whose alkaline solution temperature is above room temperature and below the boiling temperature of the alkaline solution, optionally below the boiling temperature of water. Room temperature is generally assumed to be 20° C. in the technical field. Such a starting temperature of the alkaline solution does not preclude the temperature of the resulting suspension increasing in the course of the process, including above the boiling temperature of the alkaline solution, as is more particularly elucidated below.

To distinguish the different temperature stages in the process the initial temperature established for the alkaline solution is referred to as the alkaline solution temperature. As soon as the decomposition process of the silicon-containing component, hereinbelow also referred to as dissolving or dissolving process, gets started the temperature will change on account of the incipient chemical reaction and a suspension which also contains reaction products of the dissolving process will form. The temperature established in the course of the ongoing dissolving process is here referred to as the suspension temperature, namely as the first suspension temperature. This is to be distinguished from a second suspension temperature which is established or adjusted in a later process step as specified below.

What has proven advantageous for an effective dissolving process is a temperature range of the alkaline solution temperature from 50° C. to a temperature far enough below the boiling temperature of the alkaline solution that said alkaline solution does not yet begin to boil during addition of the silicon-containing component.

The choice of the alkaline solution temperature depends on various conditions, for example the employed alkaline solution, the amount, size and state of the silicon-containing components to be added (silicon fragments or whole elements, their surface constitution and the like), the desired rate of the reaction, the realizable and desired pressure in the reactor and the like. The first suspension temperature desired for the dissolving process of the supplied materials must also be taken into account when setting the alkaline solution temperature. Both the initial alkaline solution temperature and the suspension temperature are suitable for influencing the speed of dissolving of the non-noble materials, wherein higher temperatures are suitable for acceleration of the process. The alkaline solution temperature must be adjusted to the respective application of the process by optimization through experiments.

A further parameter for influencing the process is the process pressure in the reactor during dissolving. The pressure can be used for example to actively influence the boiling temperature not only for the alkaline solution but also for the suspension and thus the reaction rate of the dissolving process. When reference is made to the boiling point of the alkaline solution in the description of the process this is always to be understood as meaning the boiling point which corresponds to the value at the selected/established process pressure in the reactor.

In the present case the reactor is a space delimited by a vessel which has been specially constructed and produced to allow certain reactions to be conducted therein under defined conditions, here especially alkaline solution, temperature and pressure and to be influenced and controlled.

In the present case dissolving is to be understood as meaning a process where the silicon-containing component in question disintegrates and dissolves in the alkaline solution and therefore reacts to afford another chemical compound. Complete dissolving of the silicon of the component is preferred. The mixture of alkaline solution and the reaction products of the dissolving process is in the present case referred to as a suspension. The silicon-containing component remains in the suspension until the silicon is dissolved, wherein in one embodiment of the process the resulting reaction solution is stirred during the process.

The first suspension temperature is maintained over the entire dissolving process of the silicon-containing component, namely such that said temperature is within a temperature range whose upper limit is limited by the boiling temperature or may optionally also be above the boiling point of the alkaline solution. Limitation of the temperature range of the first suspension temperature by a single-digit amount below the boiling point is also possible. It likewise goes without saying that an increase in the first suspension temperature above the boiling point preferably needs to be limited to only a single-figure amount to keep the reaction under control. A temperature undershoot or a temperature exceedance of the boiling point by a single-digit amount is possible for any value less than 10 degrees Kelvin, wherein the most advantageous value results from an optimization between the reaction rate and the controllability of the reaction.

The first suspension temperature may be used to influence the process in terms of its efficiency, in particular the reaction rate. Furthermore, the first suspension temperature may be limited using the process itself when the energy demand of a phase transition occurring in the alkaline solution at a temperature above the boiling point of the alkaline solution is covered by the process itself, thus preventing further increase of the first suspension temperature and thus preventing runaway of the reaction.

The temperature influences inter alia the rate of dissolving of the silicon-containing component, wherein the highest possible temperature does not necessarily provide the best result. Accordingly the suspension temperature during a process proceeding at standard pressure may be preferably in the range of 60-90° C., more preferably in the range of 70-85° C., more preferably in the range of 80-85° C., wherein divergences in the range of several degrees, i.e. less than 5 degrees, are possible without significantly influencing the result. At higher boiling temperatures the ranges of the suspension temperature may be higher by analogy to the above-specified ranges and the indicated intervals to the boiling temperature which are based on the boiling temperature of water.

Once the silicon-containing component is dissolved the suspension is in the form of a viscous reaction solution in which the silicon is present as meta-, di- and oligosilicate. Depending on the type of the dissolved silicon-containing components further constituents may be present in the reaction solution. In the case of electrically contacted silicon-containing components, such as the wafer layer of solar modules or electronic semiconductor elements the reaction solution may additionally contain noble metal as a sediment and non-noble metals as impurities in the reaction solution. If pure wafer waste is dissolved the suspension may contain predominantly or exclusively meta-, di- and oligosilicate with only minor impurities, if any.

To separate the meta-, di- and oligosilicate from the suspension the latter is withdrawn, for example subjected to vacuum filtration in the hot state via a suitable filter. The mixture is withdrawn “in the hot state” if it has a second suspension temperature which is maintained in a range from 50° C. to less than the boiling point of the alkaline solution at the process pressure p during its filtration. The second suspension temperature may be identical to or diverge from the first separation temperature. This comprehends that the suspension temperature is actively influenced before or during the filtration or on account of the value at commencement of the filtration remains in the temperature range in which the desired filtration result is achieved.

A filter is suitable for the process if it has a pore size which effects retention of the further, in particular solid, constituents of the suspension, such as the noble metal and the further aforementioned impurities of the silicon-containing component, as a filtercake and allows passage of the suspension as filtrate. A suitable filter is easily identifiable by experiments or analyses of the suspension.

The meta-, di- and oligosilicate may be recovered from the filtered suspension by washing. It may optionally be subsequently dried and sent for a very wide variety of uses as waterglass.

If, according to different embodiments of the process, an alkaline solution of a hydroxide of an alkali metal or of an alkaline earth metal or an alkaline solution of ammonium hydroxide or a mixture thereof is used to dissolve the silicon the meta-, di- and oligosilicate may be converted into silicates of different composition and hydrate forms. Sodium silicate (Na₂SiO₃) may be mixed with potassium silicate (K₂SiO₃) and/or calcium silicate (CaSiO₃) for example. Furthermore, reduction of the pH, for example by acidification with H₂SO₄ or HCl or another acid, and by standing in air via CO₂, can lead to increasing formation of different oligo- and polysilicates since silicic acids have a tendency for intermolecular water elimination to form oxygen bridges between the silicon atoms. This results in chain-lengthening (branching and non-branching) and chain-closing (ring-forming) condensation reactions, wherein the complexity of the alkali metal-silicic acid reactions is to be taken into account.

Waterglass is well-known as a water-soluble silicate comprising glass-like, i.e. amorphous, non-crystalline, compounds of composition M2O·n SiO2 where n=1 to 4. The following applications employ for example

potassium silicate or else sodium silicate, the latter while ensuring suitable measures for protection from its health-hazardous effects. The water-soluble silicates find uses for example in construction, in binders, in fire retardant materials, as buffers and stabilizers for chemicals (e.g. H2O2), for briquetting of coal, in paper recycling, in the coating of paper, for metal degreasing and many other fields. They are also present in washing compositions, bleaching solutions, soaps, cleaning compositions, cements, mortars, ceramic articles, paints and cosmetic preparations. Potassium silicates are used as binders, adhesives (for mineral paints and renders, refractory mortars, building materials), as fire retardant materials for wood and in so-called plant fortifiers.

In a further embodiment of the process the process of dissolving can also be accelerated through addition of auxiliaries which for example improve the wetting of the silicon-containing component or the particles thereof by the alkaline solution. Isopropanol for example is suitable therefor. The use of basic surfactants or phase transfer catalysts such as quaternary ammonium salts is also possible. It is also possible to employ other materials suitable for reducing the surface tension of the alkaline solution and thus improve wetting.

Also desired in addition to an efficient process management with an optimal reaction rate is a highest possible energy gain from the exergonic reaction which is likewise possible by means of the higher suspension temperatures within the recited temperature ranges.

The formation of meta-, di- and oligosilicate proceeds highly exergonically, especially in the aforementioned alkaline solutions and especially in potassium oxide solution and sodium hydroxide solution. That is to say that the free enthalpy of the reaction products is lower than the sum of the free enthalpy of the starting materials, thus resulting in liberation of heat in the course of the process. On account of this the energy for establishing, i.e. generating and maintaining, the first and/or second suspension temperatures of 50° C. and more specified above for the process, optionally also the alkaline solution temperature, may be partially, predominantly or else exclusively covered by the energy gain. The energy employable for this purpose may be recovered from the ongoing process or, especially in the case of the alkaline solution temperature for initial establishment, a preceding process according to the disclosure.

In the case of a continuous process operation for example the energy gain from the ongoing process is realizable as specified below. Alternatively, the ongoing process may also be actively influenced when in one embodiment of the process the suspension temperature TS1 or the suspension temperature TS2 or both are established and/or maintained over the course of the process by a metered addition of an alkali metal and/or metal hydroxide. For instance the solids of potassium hydroxide have a high solution enthalpy of −57.1 kJ/mol. The reaction enthalpy is −424 kJ/mol and the reaction entropy is 159 J/K. At 80° C., this gives a free reaction enthalpy of about −480 kJ/mol for the sodium metasilicate (Na2SiO3).

In one embodiment of the process the starting temperature of the alkaline solution can thus be brought to the desired temperature in the aforementioned temperature range by dissolving the hydroxide in water with stirring to produce the alkaline solution. Through a simple calculation and/or monitoring of the temperature during addition of the hydroxide to the water the starting temperature is optionally achievable without external energy input.

The same applies to maintaining the first suspension temperature over the course of the process. For this reason too the hydroxide may be metered into the suspension. The metered addition may be determined by experiments and/or temperature monitoring and/or by calculation. On account of the above-described process sequence and the associated influencing of the second suspension temperature using the first, the above also applies indirectly to the second suspension temperature. However, external energy input is not excluded. For example a precipitation of the silicates in the filter can be avoided or at least significantly reduced through post-heating in the filtration.

In a further embodiment ultrasound may be introduced into the alkaline solution or into the suspension using a suitable ultrasound source, in the first case to bring about commencement of the reaction or in the second case to promote or to accelerate the reaction. Partial external energy input can make large industrial scale processes more efficient.

If the silicon-containing components contain noble metals these may be separated from the suspension by capturing the noble metal in the filtercake during filtering of the suspension in one embodiment of the process. The noble metals of the silicon-containing component, such as silver or gold or others, do not react with the alkaline solution and accumulate on the reactor bottom as a solid on account of their density. They are in elemental form, i.e. in the oxidation state 0 and may be separated as “solid precipitate”. In one embodiment of the process the noble metal may subsequently be purified and, depending on the metal, also concentrated.

Purification may be effected through electrochemical deposition at electrodes for example. However, the solid precipitate may also be dissolved in water using nitric or methyl sulfonic acids as the salts thereof and subsequently precipitated as halides, sulfides or sulfates. The noble metals may also be brought into the reaction solution with complex formers such as cyanides, thiocyanates, thiosulfates or amines in order to subsequently precipitate these with the aforementioned substances in purified form. Silver may be brought into solution as a chloro complex with iron (III) chloride in salt solutions such as for example with sodium chloride or calcium chloride solutions and subsequently re-precipitated by dilution with water. A person skilled in the art is familiar with further methods for purifying silver and gold and also further noble metals to the extent these are present in a silicon-containing component.

The non-noble metals present in the silicon-containing component such as aluminum, tin, lead or further examples are preferably completely dissolved in the alkaline solution to form hydrogen. In solar modules these materials arise in such a small amount that they may remain as impurities while exerting only an unconcerning influence on the meta-, di- and oligosilicate, if any. Lead or the aluminum oxide from the reverse-side contacting of solar wafers for example is unconcerning for the production of waterglass for the construction industry.

A further positive recovery effect of silicon-containing components is the formation of hydrogen as an energy carrier as a result of the dissolving of the silicon and the non-noble metals of a silicon-containing component in the alkaline solution.

It is apparent from the aforementioned equation for dissolving of silicon in potassium hydroxide solution that two mol of silicon result in one mol of potassium disilicate and four mol of hydrogen. Formation of hydrogen applies to each of the aforementioned alkaline solutions. This reaction consequence has at least two advantageously utilizable aspects.

In one embodiment the dissolving of the silicon-containing component in the alkaline solution may be detected and the next process step initiated by means of the hydrogen production. Accordingly in a further embodiment of the process the formation of hydrogen is monitored and termination thereof is indicated by sensor. Furthermore, the hydrogen itself may be sent for recovery as an energy carrier.

The hydrogen formed in the process is mainly generated by the silicon since this accounts for the greatest volume. 1 kg of silicon can thus produce about 1600 liters or 144 g of hydrogen. It appears that this effect is greatest especially upon recovery of modern solar modules.

The hydrogen can be collected and extracted, for example, using a bell-shaped cover over the alkaline solution bath. The hydrogen is then filled into pressure vessels in a compressed state and sent to a new use. In a further embodiment of the process a first compression stage of the hydrogen may already be realized at the outlet of the reactor to facilitate storage, transport and liquefaction of the hydrogen formed for energy recovery of the silicon-containing components. For instance a compression apparatus may be connected by a flange to a gas outlet of the reactor and the hydrogen compressed to a second higher pressure level. The compression apparatus can also effect a drying and cooling of the hydrogen.

In further embodiments of the process the starting materials and the suspension may be continuously supplied or discharged (continuous process) without interrupting the process of dissolving. Alternatively the process may be run such that the process is also not interrupted but at least one of the starting materials and end products is discontinuously supplied or discharged (semi-continuous process). Both variants are advantageous for large industrial scale application of the process, since, by contrast, the discontinuous process inevitably entails downtime in which after each batch the reactor must be shut down, emptied, re-charged with starting materials and run up to process parameters again.

The fact that the supplied and not yet dissolved silicon fragments float on the surface of the already formed suspension, whereas the silver and other noble metals settle as sediment, makes it possible to separate the suspension to be treated in the next process step with its impurities from the still to be dissolved silicon fragments during the reaction. The factors that are rate-determining in the strongly exergonic reaction and that will therefore become relevant for a continuous or semi-continuous process mode are especially rapid heat removal and the capturing of the hydrogen and, related thereto, the supply of silicon fragments and the further starting materials.

The material and energy utilization of the process may be summarized as follows:
The process consists of the preferably complete dissolving of semiconductor silicon from electronic waste using an alkaline solution.
Aside from a purification of the noble metal to be performed subsequently only a single chemical, namely a alkaline solution, for example potassium hydroxide solution or sodium hydroxide solution, is required. The process does not employ hydrofluoric acid or further chemicals for dissolving of solids.
For many process variants the recovery of silicon-containing components is linked to the recovery of waterglass in various embodiments. Waterglass is a material that is used extensively in industry and in numerous products.
Due to their density, nobler metals such as silver accumulate as a solid as a dark precipitate at the bottom of the reactor. By contrast, the silicon floats on the surface of the already formed suspension, so that the two materials are separable by filtration.
The process may be run exergonically on account of the high solution enthalpies (from production of the alkaline solution) and the reaction enthalpies of the reactants, thus making it possible to obtain heat to perform the process or for other uses.
The process proceeds with formation of hydrogen which may be captured and sent to an energy recovery. Due to the large quantities of solar modules for recycling that are generated, the recoverable hydrogen amount is an amount that is efficient to recover.
Non-noble metals such as aluminum on the surface of the semiconductor silicon are dissolved in the alkaline solution and likewise contribute to hydrogen production.
Due to the separation of the silicon fragments floating in the alkaline solution the process may also be operated in continuous or at least semi-continuous fashion, thus making it suitable for large industrial scale application.

### BRIEF DESCRIPTION OF THE DRAWING

The sole figure shows a flowchart of a process for recovery of materials present in silicon-containing components.

### DETAILED DESCRIPTION

The invention shall now be more particularly elucidated hereinbelow using a working example with reference to a flow diagram (Fig.). The process sequence is only described to the extent to which it is necessary for understanding of the invention. The description does not claim to specify the process sequence in its entirety.

The process may be commenced in various ways. This may comprise initially mixing the hydroxide according to the above description and water, into which subsequently the fragments of silicon-containing components, hereinbelow also referred to as silicon fragments for short, are supplied in controlled fashion. Alternatively, a suspension of the silicon fragments and water may be the starting point of the process. In this case, the hydroxide is supplied in controlled fashion in the subsequent step. In both cases water, alkaline solution and the silicon-containing components represent the substantial, optionally sole, starting materials of the process.

In the exemplary embodiment which follows the first of the two aforementioned alternatives are more particularly elucidated. The second alternative differs from the first alternative in the further process sequence only in that the material subsequently supplied in controlled fashion, i.e. in temperature-dependent fashion, is the hydroxide instead of the silicon fragments.

In the working example an alkaline solution 1 suitable for silicon dissolution, for example sodium hydroxide, is dissolved by stirring 3 in water 2 under standard pressure, wherein the quantity ratios of both starting materials are measured such that this solution temperature increases to approximately T=80° C. on account of the exergonic reaction. The comminuted fragments 4 of silicon-containing components, referred to for short as “BE” having particle sizes of <1 cm are added portionwise and monitored by temperature measurements 5, such that the suspension temperature now prevailing does not exceed T 95° C. and that the resulting foam does not exit the reactor. If the suspension temperature T increases significantly above 85° C. 6 during addition of silicon fragments 4 the supply thereof is reduced 7.

After complete addition of the silicon fragments 4 the mixture is stirred at 80° C. for a further 4 h until the solid has dissolved with the exception of the silver. This affords a suspension 8 which contains sodium meta-, di- and oligosilicate and a noble metal, optionally also further noncritical impurities.

The hydrogen 9 formed during decomposition of the silicon is discharged for external storage. The formation of hydrogen 9 is monitored 10 so that the dissolving of the added silicon fragments can be detected by reference to the terminated hydrogen formation. In the exemplary embodiment the dissolving of about 380 g of silicon resulted in over 608 L of hydrogen, determined with a gas counter, in this reaction.

The silver of the silicon fragments 4 is then separated from the suspension 8 by hot filtration 11. By way of example, but without limitation, the silver is separated by vacuum filtration in the hot state via a suitable filter whose pore size is adapted to the noble metal particles and is washed with hot water, i.e. likewise with water temperatures in the above-mentioned temperature range, and optionally dried. The filtrate without washing water may be used as waterglass 12, i.e. sodium meta-, di- and oligosilicate in the working example.

The filter may be a G3 frit for example. A frit is a filter made of porous glass or porous ceramic, with the result that the silver for filtration does not pass the fine pores. Type G3 denotes the pore size which is in the range of 16-40 μm. This affords a filtrate which passes through the filter and contains dissolved silicon and a so-called filtercake which refers to the residue remaining in the filter and in the present case contains the noble metal 13 silver.

Subsequently the silver-containing filtercake is dissolved in half-concentrated nitric acid, 20-30% nitric acid, at 60° C. with stirring. The mixture is then subjected to vacuum filtration through a G4 frit (pore size 10-16 μm) and the filtrate mixed with a sodium chloride solution. The resulting silver chloride precipitate is subjected to vacuum filtration through a G4 frit and thoroughly cleaned with water 14. The precipitate is dissolved in dilute sodium hydroxide solution and reduced to metallic silver with sucrose. The silver precipitate is subjected to vacuum filtration and dried. Hydrogen formed may likewise be captured pneumatically, thus further improving the energy balance of the process (not shown). Other processes for silver recovery are also possible, for example the pressing 28* of the silver-containing filtercake via anode plates and subsequent purification of the silver by electrolytic means. In this variant the noble metal fractions such as for example gold, platinum, palladium or others are enriched in the anode sludge and obtained therefrom as described above.

I claim:

1.-15. (canceled)

16. A process for recovery of materials present in silicon-containing components comprising the following successive process steps:
providing a silicon-dissolving alkaline solution in a reactor;
adjusting a process pressure (p) in the reactor and an alkaline solution temperature (TL), which is in a range from 50° C. to less than a boiling temperature of the alkaline solution at the process pressure (p);
supplying a silicon-containing component to the alkaline solution and dissolving silicon of the silicon-containing component in the alkaline solution to generate and maintain a first suspension temperature (TS1) and to form a suspension containing meta-, di-, and oligosilicates,
wherein the first suspension temperature (TS1) is at least 50° C.;
filtering the suspension to separate the meta-, di-, and oligosilicates from a filtrate at a second suspension temperature (TS2),
wherein the second suspension temperature (TS2) of the suspension is maintained in a range from 50° C. to less than a boiling point of the alkaline solution during filtering.

17. The process as claimed in claim 16,
wherein the silicon-dissolving alkaline solution is an alkaline solution of a hydroxide of an alkali metal, an alkaline earth metal, or of ammonium hydroxide.

18. The process as claimed in claim 16,
wherein the first suspension temperature (TS1) and/or the second suspension temperature (TS2) are established using thermal energy from an exergonic reaction of the dissolving of the silicon.

19. The process as claimed in claim 16,
wherein the alkaline solution temperature (TL) is established using thermal energy from an exergonic reaction of the dissolving of the silicon from a preceding process or an ongoing process.

20. The process as claimed in claim 16,
wherein the first suspension temperature (TS1) and/or the second suspension temperature (TS2) are established and/or maintained by a metered addition of an alkali metal and/or metal hydroxide.

21. The process as claimed in claim 16, further comprising
introducing ultrasound into the alkaline solution or into the suspension by an ultrasound source.

22. The process as claimed in claim 16, further comprising
stirring the suspension during the dissolving of the silicon.

23. The process as claimed in claim 16, further comprising
washing the filtrate to obtain the meta-, di-, and oligosilicates.

24. The process as claimed in claim 16, further comprising
comminuting the silicon-containing component before addition thereof to the alkaline solution.

25. The process as claimed in claim 16,
wherein the silicon-containing component comprises a noble metal and the noble metal is captured in a filtercake.

26. The process as claimed in claim 16, further comprising
adding auxiliaries suitable for improving a wetting of the silicon-containing component with the alkaline solution to the alkaline solution.

27. The process as claimed in claim 16, further comprising
monitoring a formation of hydrogen due to the dissolving of the silicon-containing component in the alkaline solution and
determining termination of the dissolving of the silicon based on a hydrogen quantity formed.

28. The process as claimed in claim 16, further comprising
capturing hydrogen resulting from the dissolving of the silicon-containing component in the alkaline solution and
sending the hydrogen to an energy recovery.

29. The process as claimed in claim 28,
wherein the process is performed with two pressure stages, and
wherein a second of the two pressure stages has a higher pressure than a first of the two pressure stages and adjoins an outlet side of the reactor.

30. The process as claimed in claim 16,
wherein the process is operated
in continuous fashion with continuous supply of starting materials and continuous withdrawal of the suspension or
in semi-continuous fashion, wherein a supply of a starting material and/or a withdrawal of the suspension are carried out discontinuously.

31. The process as claimed in claim 16,
wherein the process pressure (p) is standard pressure.
